(19) United States
(12) Patent Application Publication
(10) Pub. No.: US 2015/0260124 A1
(43) Pub. Date: Sep. 17, 2015

(54) PISTON FOR AN INTERNAL COMBUSTION ENGINE

(71) Applicant: COMPONENTA FINLAND OY, Karkkila (FI)

(72) Inventors: Sakari Pisilä, Kokkola (FI); Tommy Rönnskog, Jakobstad (FI)

(21) Appl. No.: 14/433,976

(22) PCT Filed: Oct. 8, 2012
(86) PCT No.: PCT/FI2012/050963

§ 371 Date: Apr. 7, 2015

(51) Int. Cl. F02F 3/22; F02F 3/00

(52) U.S. Cl. CPC F02F 3/22; F02F 3/0023

(57) ABSTRACT

A piston assembly for an internal combustion diesel engine having a piston diameter of 160 to 650 mm, includes a top part, a body part and a cooling gallery arranged as a hollow space there between, the top part defining, when installed in an engine cylinder, the piston side of a combustion chamber, and the body part having an aperture for a gudgeon pin, bosses for distributing forces, when in use, between the piston and the gudgeon pin. The body part has an interior, an outer surface including indentations defined by the outer surfaces of the bosses and an imaginary boundary of the cylinder of the engine. The interior side of the top part forms an inner cooling surface for piston cooling fluid to flow along and cool the central area of the top part, and the body part includes a conduit extending between the indentation and the cooling gallery.

The present invention relates to the field of combustion engines, more specifically to a piston assembly for an internal combustion diesel engine having a piston diameter of 160 to 650 mm, the piston assembly comprising a top part and a body part and a cooling gallery arranged between the top part and the body part,
the top part defining, when installed in a cylinder of the engine, the piston side of a combustion chamber, and
the body part having an aperture for a gudgeon pin, bosses for distributing forces, when in use, between the piston and the gudgeon pin, the body part having an interior, an outer surface comprising indentations defined by the outer surfaces of the bosses and an imaginary boundary of the cylinder of the engine, and
the cooling gallery is arranged as a hollow space between the top part and the body part wherein an amount of piston cooling fluid can be led to remove the superfluous heat from the piston assembly, and
the interior side of the top part is arranged to form an inner cooling surface for piston cooling fluid to flow along and cool the central area of the top part.

Large internal combustion engines are widely used in demanding power supply tasks in electric power plants, as a power source of ship propulsion systems, etc.

In large internal combustion engines there is an increasing demand in having more power out of the engine with the same cylinder displacement. An aim is to increase the power rate and simultaneously decrease emissions caused by the engine. One route towards these results is the increase in cylinder pressure when in operation. On the other hand the reliability of these large engines must also improve i.e. any failures in operation are highly unwanted. This causes development needs to all parts of these engines, pistons included.

An objective of the present invention is to provide a piston for large size internal combustion diesel engines, having a piston diameter in a range of 160 mm to 650 mm. The objective of the invention is to provide a piston, which can withstand increased cylinder pressures in operation for long periods of time.

Especially the ability to withstand fatigue at elevated power rates of the internal combustion diesel engine is one objective of the present invention. While having a challenging technical task of developing a piston for these increased demands, also the economical aspect of the piston production need to be taken account. A piston is preferably manufactured in such a way that a unit price for one piston is not too high. Therefore a balance of manufacturing costs and technical excellence must be taken in to consideration. At current markets for large sized piston, it is still a product which should not be too expensive and at the same time technically as imperceptible as possible, just working the whole life time of the engine without causing any troubles.

Another object of the present invention is to provide a piston assembly comprising a top part, a body part, which can withstand increased cylinder pressures that usually means also higher temperatures. The piston assembly is configured to have a cooling gallery inside for keeping the piston temperature effectively in an acceptable level. Thus, an aim is to provide an effective way to cool the piston assembly. An objective of the invention is also to improve the efficiency of the engine by reducing the power consumed by internal processes of the engine. In general, the objective is to reduce the manufacturing costs and simplify the engine design, which may also have positive effect on the fatigue resistance of the piston assembly, gudgeon pin or the connecting rod.

The present invention of the piston assembly is characterized in that the body part is provided with a conduit for said cooling fluid, said conduit is extending between the indentation and the cooling gallery.

When there is provided a conduit for said cooling fluid, said conduit is extending between the indentation and the cooling gallery, the cooling fluid may be provided externally or from outside of the piston to the cooling gallery by an injection or jet-type arrangement via the indentation for the bosses. This indent type of piston is commonly called as box-type piston, where the sleeve of the piston (or body part) is more like box-shaped than conventional round sleeved. Said indentations are indenting from the imaginary cylindrical shape of the piston and are defined by the outer surfaces of the bosses and an imaginary boundary created by the cylinder of the engine. The indentation gives room for a cooling fluid to be injected and this route to apply the cooling fluid to the cooling gallery gives several positive effects to the piston design and also to the engine design. First of all the normal conduits for supplying the cooling fluid through the connecting rod, gudgeon pin and body part can be avoided. This simplifies the design. Those moving parts are subject to an acceleration caused by the reciprocating motion of the piston in a running engine. In some engines this acceleration may exceed 200 G (where 1 G is 9,81 m/s²). If the cooling fluid is applied through these parts, the acceleration must be taken in to account in designing the cooling fluid pump. This may in practice mean, that the cooling fluid pump consumes extra energy to overcome the effect of the acceleration to the fluid flow. Thus the objective of improving the internal effectiveness or reduce the power consumed by internal processes of the engine is achieved. Also the external route gives more freedom to design and dimensioning of the gudgeon pin, connecting rod and body part if the cooling fluid does not need to be delivered to the cooling gallery or to the interior of the piston assembly via the connecting rod or by injecting just beside the connecting rod i.e. between connecting rod and the sleeve of the body part to the interior or dome of the piston.

The conduit has preferably an inlet which is located at a top wall of the indentation. By using this location, the conduit may be formed quite short and the injected cooling fluid is quite easy to capture in to the conduit. The conduit inlet may be provided with a receiving element to form the cooling fluid flow capturing part of the conduit to capture and steer an injected cooling fluid stream to the conduit and further to the cooling gallery. This receiving element may be formed as or it may have a funnel shape, is a hole like opening or has another corresponding shape. The purpose of this shape is to ensure that the injected cooling fluid enters the cooling gallery, not to the indentation or to the clearance between the moving piston and the cylinder.

The piston assembly is preferably designed so that the conduit outlet is disposed at the cooling gallery in a location where the body part side of the cooling gallery forms a bowl having a volume for the cooling fluid. Also it is preferred that the body part, the top part or the boundary in between the body part and the top part is provided with an exit conduit for the cooling fluid to exit from the cooling gallery to the inner cooling surface i.e. the interior or dome inside of the piston. By this arrangement the cooling fluid flow may be determined so that there is a constant flow with predetermined direction so that the flow enters from outer area and exits at the interior side of the piston assembly on to the connecting rod and further to a crankshaft casing.

Also the cross-section area of the conduit can be determined according to a wanted flow rate. Also when the formation of the oil channel is avoided at the body part or gudgeon pin surface, as a so called oil groove, the bearing surface area of the gudgeon pin may be increased. The increase in the bearing surface area affects directly to the fatigue resistance in the manner of decreased surface pressure but in addition also the load can be increased.

For supplying the cooling oil to the cooling gallery between the body part and the top part the conduit need to be designed in a certain diameter or cross sectional area depending on the needed cooling capacity of the oil. One factor determining the flow rate at the conduit is a capacity of cooling fluid pump such as a primary oil pump, but also the directions of said conduits and the acceleration caused by the reciprocating motion of the piston in a running engine. In some engines this acceleration may exceed 200 G (where 1 G is 9,81 m/s²) and therefore the directions of the conduits in relation to the acceleration directions affect significantly to the flow of the cooling fluid.

In this context a cooling gallery means a hollow space between the top part and the body part of the piston wherein an amount of piston cooling fluid (normally lubrication oil) can be led for removing the superfluous heat caused by combustion of fuel in the cylinder. The cooling gallery is preferably shaped as a toroid like shape to the boundary between the top part and the body part. It may have only one conduit or number of conduits for supplying the cooling fluid in to the cooling gallery. This number is a design parameter which can be determined on the basis of the needed cooling capacity. The same holds with an exit channel. Preferably the conduit outlet and the exit conduit are disposed at the cooling gallery in such locations that in a steady state situation the cooling gallery forms a bowl capable of contain cooling fluid at a range of 25 to 65% degree of fullness compared to the total volume of the cooling gallery. Within this range the cooling capacity is quite optimal and the piston assembly acts as a shaker of cooling fluid within the cooling gallery and performs the cooling action in very effective manner. The mentioned steady state situation means here a situation where the engine is running (already for some time so that also the temperatures of engine parts are steady) and the piston assembly is subject to accelerations of running engine, the top part is facing upwards and a central axis of the piston assembly is in vertical orientation.

In the following the invention will be described in detail with reference to the accompanying figures wherein:

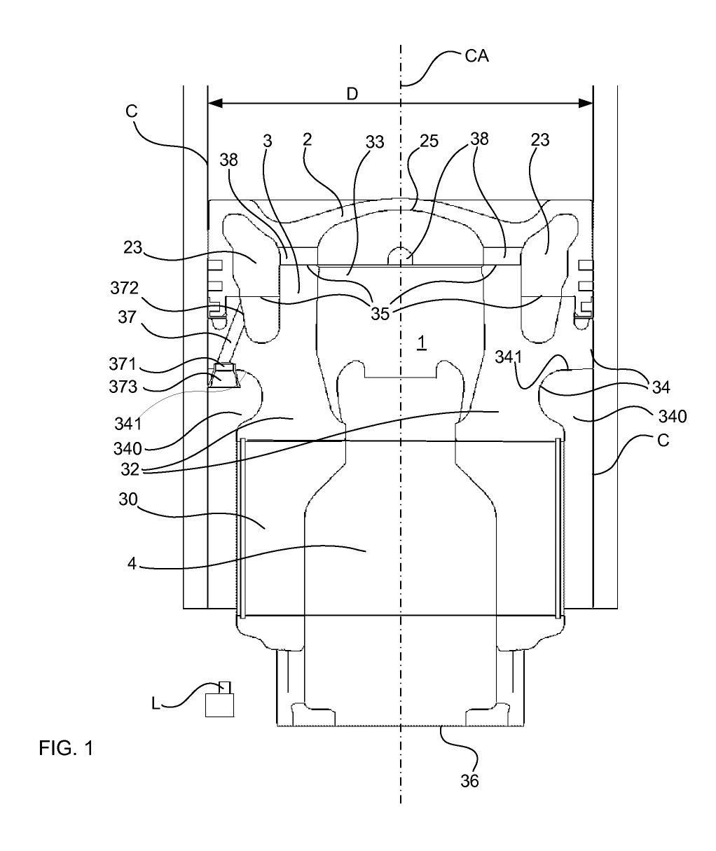

FIG. 1 presents an over view of a piston assembly,

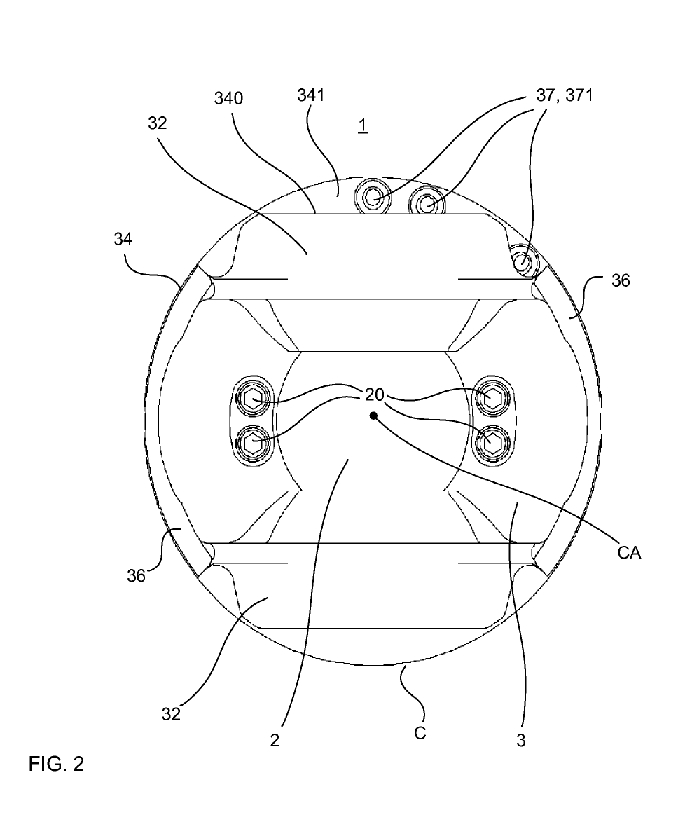

FIG. 2 presents an embodiment of the piston assembly where there are presented several options for location of cooling fluid inlets.

In FIG. 1 there is presented a piston 1 assembly for an internal combustion diesel engine having a piston diameter D of 160 to 650 mm, the piston 1 assembly comprising a top part 2 and a body part 3 and a cooling gallery 23 arranged between the top part 2 and the body part 3,
the top part 2 defining, when installed in a cylinder C of the engine (direction of motion of the piston assembly when running in the engine is along a central axis CA of the piston assembly), the piston 1 side of a combustion chamber, and
the body part 3 having an aperture 30 for a gudgeon pin 4, bosses 32 for distributing forces, when in use, between the piston 1 and the gudgeon pin 4, the body part 3 having an interior 33, an outer surface 34 comprising indentations 340 defined by the outer surfaces 34 of the bosses 32 and an imaginary boundary of the cylinder of the engine, and
the cooling gallery 23 is arranged as a hollow space between the top part 2 and the body part 3 wherein an amount of piston cooling fluid can be led to remove the superfluous heat from the piston assembly, and
the interior side of the top part 2 is arranged to form an inner cooling surface 25 for piston cooling fluid to flow along and cool the central area of the top part 2,
the body part is provided with a conduit 37 for said cooling fluid, said conduit 37 is extending between the indentation 340 and the cooling gallery 23.

In the embodiment of FIG. 1 the conduit 37 has an inlet 371 which is located at a wall 341 of the indentation 340 on the side of the top part 2. The conduit inlet 371 is provided with a receiving element 373 to form the cooling fluid flow capturing part of the conduit 37 to capture and steer an injected cooling fluid stream (from a nozzle L of the engine) to the conduit 37 and further to the cooling gallery 23. The receiving element 373 has a funnel shape, is a hole like opening or may have another corresponding shape.

Still in the embodiment of the FIG. 1, the conduit outlet 372 is disposed at the cooling gallery 23 in a location where the body part side of the cooling gallery forms a bowl having a volume for the cooling fluid. According to an embodiment the conduit outlet 372 and the exit conduit are disposed at the cooling gallery in such locations that in a steady state (engine is running in normal mode) the cooling gallery forms a bowl capable of contain cooling fluid at a range of 25 to 65% degree of fullness compared to the total volume of the cooling gallery. The purpose of this feature is to ensure that in the cooling gallery 23 there is a certain amount of cooling fluid inside when the engine is running and the cooling capacity is adequate.

During running of the engine the amount of cooling fluid is remaining constant i.e. the volume flow in to the cooling gallery is the same as the exit volume. Thus the conduit outlet 372 and the exit conduit 38 are disposed at the cooling gallery in such a locations respect to each other that, when in use, the reciprociting strokes of the piston creates a shaker effect to the cooling fluid within the cooling gallery and where an constant amount of cooling fluid may enter and exit the cooling gallery during one cycle consisting of one forward and one backward stroke. It is also advantageous, that the flow direction remains as designed, the cooling fluid enters from the inlet 371 and exits via the exit conduit(s) 38, not via inlet conduit 37.

The body part 3, the top part 2 or the boundary 35 in between the body part and the top part is provided with an exit conduit 38 for the cooling fluid to exit from the cooling gallery 23 to the inner cooling surface. This inner cooling surface is in most embodiments the interior or the dome of the top part 2. As the cooling gallery is normally shaped as an annular ring shape, the inner cooling surface takes care of cooling the central area of the top part 2.

In FIG. 2 it is presented a piston assembly 1 as seen from the direction of a connecting rod and a gudgeon pin (positioned in vertical orientation, not shown). The piston assembly 1 shown is of box-type piston configuration where there is a top part 2 fastened to a body part 3 with fastening bolts 20. The body part 3 comprises bosses 32 for distributing forces from the piston assembly 1 to a connecting rod (not shown). The bosses 32 are indented 340 from the generally circular shape of the piston assembly 1. The body part 3 of a box type configuration has a circular outline near the top part 2 but more square shaped outline by the bosses 32 and by the sleeves 36. However, on the circumference of the sleeve 36, the area near the bosses 32 is more flat (box-like) and the area of the sleeve 36 perpendicular to gudgeon pin direction is following the shape of the cylinder of the engine at a distance of normal running clearance.

As the piston assembly in FIG. 2 is shown from the direction of a connecting rod, the conduit 37 is extending between the indentation 340 and the cooling gallery 23 (not shown in FIG. 2) and is located at the top (or near to) wall 341 of the indentation 340, which is in this perspective in the plane of FIG. 2. The three conduits 37 and conduit inlets 371 shown in FIG. 2 are shown as equal options to each other, only illustrating three of the different possible locations where the conduit inlet may be located. The actual location depends on the engine design and thus it is not discussed with the present invention. There may be more than one conduit 37/conduit inlet 371 if needed, located for example at the other indentation of the body part. Also the top wall may be in a plane perpendicular to the central axis CA of the piston assembly or it may be inclined in some direction. The diameter of the conduit inlet 371 may be selected within a range so that it is so large that the cooling fluid stream may be captured in to the conduit 37 and it is so small that the conduit inlet 371 does not affect too much to the overall design, strength, durability, machinability etc. of the body part 3.

### REFERENCE SIGNS IN THE FIGURES

1 Piston assembly

2 top part

20 fastening bolts

23 cooling gallery

25 inner cooling surface

3 body part

30 aperture for gudgeon pin

32 boss

33 interior of body part

34 outer surface

340 indentation

341 indentation wall by near the top part

35 boundary

36 sleeve

37 conduit

371 conduit inlet

372 condut outlet

373 receiving element

38 exit conduit

4 gudgeon pin

CA central axis of the piston assembly

C cylinder of the engine

D diameter

1. A piston (1) assembly for an internal combustion diesel engine having a piston diameter (D) of 160 to 650 mm, the piston (1) assembly comprising a top part (2) and a body part (3) and a cooling gallery (23) arranged between the top part (2) and the body part (3),
the top part (2) defining, when installed in a cylinder (C) of the engine, the piston (1) side of a combustion chamber, and
the body part (3) having an aperture (30) for a gudgeon pin (4), bosses (32) for distributing forces, when in use, between the piston (1) and the gudgeon pin (4), the body part (3) having an interior (33), an outer surface (34) comprising indentations (340) defined by the outer surfaces (34) of the bosses (32) and an imaginary boundary of the cylinder (C) of the engine, and
the cooling gallery (23) is arranged as a hollow space between the top part (2) and the body part (3) wherein an amount of piston cooling fluid can be led to remove the superfluous heat from the piston assembly (1), and
the interior side of the top part (2) is arranged to form an inner cooling surface (25) for piston cooling fluid to flow along and cool the central area of the top part (2),
wherein,
the body part is provided with a conduit (37) for said cooling fluid, said conduit (37) is extending between the indentation (340) and the cooling gallery (23).

2. The piston assembly according to claim 1, wherein the conduit (37) has an inlet (371) which is located at a top wall (341) of the indentation (340).

3. The piston assembly according to claim 1, wherein the conduit inlet (371) is provided with a receiving element (373) to form the cooling fluid flow capturing part of the conduit (37) to capture and steer an injected cooling fluid stream to the conduit (37) and further to the cooling gallery (23).

4. The piston assembly according to claim 3, wherein the receiving element (373) has a funnel shape, is a hole like opening or has another corresponding shape.

5. The piston assembly according to claim 1, wherein the conduit outlet (372) is disposed at the cooling gallery (23) in a location where the body part (3) side of the cooling gallery forms a bowl having a volume for the cooling fluid.

6. The piston assembly according to claim 1, wherein the body part (3), the top part (2) or the boundary (35) in between the body part and the top part is provided with an exit conduit (38) for the cooling fluid to exit from the cooling gallery (23) to the inner cooling surface (25).

7. The piston assembly according to claim 6, wherein the conduit outlet (372) is disposed at the cooling gallery (23) in a location where the body part (3) side of the cooling gallery forms a bowl having a volume for the cooling fluid, and the conduit outlet (372) and the exit conduit (38) are disposed at the cooling gallery (23) in such locations that in a steady state situation the cooling gallery (23) forms a bowl capable of containing cooling fluid at a range of 25 to 65% degree of fullness compared to the total volume of the cooling gallery (23).

8. The piston assembly according to claim 6, wherein the conduit outlet (372) is disposed at the cooling gallery (23) in a location where the body part (3) side of the cooling gallery forms a bowl having a volume for the cooling fluid, and the conduit outlet (372) and the exit conduit (38) are disposed at the cooling gallery (23) in such a location with respect to each other that, when in use, the reciprocating strokes of the piston assembly (1) create a shaker effect to the cooling fluid within the cooling gallery (23) and where a constant amount of cooling fluid may enter and exit the cooling gallery (23) during one cycle consisting of one forward and one backward stroke.
